(19) United States
(12) Patent Application Publication
(10) Pub. No.: US 2010/0158483 A1
(43) Pub. Date: Jun. 24, 2010

(54) IMAGE PROCESSING APPARATUS, METHOD FOR CONTROLLING IMAGE PROCESSING APPARATUS, AND RECORDING MEDIUM

(75) Inventor: Yosuke Yamada, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/636,577

(22) Filed: Dec. 11, 2009

(30) Foreign Application Priority Data
Dec. 24, 2008 (JP) 2008-328016

(51) Int. Cl. H04N 5/91

(52) U.S. Cl. 386/95; 386/95; 386/E05.003

(57) ABSTRACT

An image processing apparatus is configured to cause a display unit to display image data segments and subtitle data segments. The image processing apparatus includes an input unit configured to input image data segments, an extraction unit configured to extract subtitle data segments and time information that associates the subtitle data segments and the image data segments with each other from the image data segments, a control unit configured to create a list of the subtitle data segments and control a subtitle data segment corresponding to an image data segment to be displayed on the display unit so that the subtitle data segment can be distinguished from the other subtitle data segments, and an output unit configured to output the image data segment and the list of the subtitle data segments created by the control unit to the display unit.

### BACKGROUND OF THE INVENTION

1. Field of the Invention

The present invention relates to an image processing apparatus in which image data and subtitle data are displayed on a display while being associated with each other.

2. Description of the Related Art

An image processing apparatus according to the related art allows a user to refer to image data segments by performing fast-forwarding/fast-rewinding on an image data segment being displayed or by moving through chapters. Japanese Patent Laid-Open No. 2006-245907, for example, discloses a reproduction apparatus that displays a list of subtitle data segments and that allows a user to select a subtitle data segment from the list of subtitle data segments in order to display, as a still image, an image data segment associated with the subtitle data segment. The reproduction apparatus further allows the user to perform a reproduction operation on the displayed still image.

Unfortunately, such an image processing apparatus of the related art can only display a list of subtitle data segments and has a problem in that a user cannot locate the position, in the list of subtitle data segments, of a subtitle data segment that is associated with an image data segment during a reproduction of the image data segment. That is, when a user reproduces image data in an environment where sound cannot be output or when a user who is hard-of-hearing views image data, the user cannot obtain information corresponding to the image data (audio data or subtitle data). Further, in a case where an image data segment contains a scene having no subtitle data (for example, a scene in which only scenic images are to be reproduced), a user cannot visually recognize that there is no subtitle data for that scene. Furthermore, as there is no corresponding subtitle data segment, the user cannot display an image data segment for such a scene by performing an operation on a corresponding subtitle data segment to display the scene.

### SUMMARY OF THE INVENTION

The present invention provides an image processing apparatus and a method for controlling the image processing apparatus that allow a user to refer to a subtitle data segment in a list of subtitle data segments, corresponding to an image data segment.

An image processing apparatus according to an aspect of the present invention is configured to cause a display unit to display image data segments and subtitle data segments, and includes an input unit configured to input image data segments, an extraction unit configured to extract subtitle data segments and time information that associates the subtitle data segments and the image data segments with each other from the image data segments input by the input unit, a control unit configured to create a list of the subtitle data segments to be displayed on the display unit and, based on an image data segment to be displayed on the display unit and the time information extracted by the extraction unit, control a subtitle data segment corresponding to the image data segment in the list of the subtitle data segments so that the subtitle data segment can be distinguished from the other subtitle data segments in the list of the subtitle data segments, and an output unit configured to output the image data segment and the list of the subtitle data segments created by the control unit to the display unit.

Further features of the present invention will become apparent from the following description of exemplary embodiments with reference to the attached drawings.

### BRIEF DESCRIPTION OF THE DRAWINGS

FIG. 1 is a block diagram illustrating a main part of an image processing apparatus according to a first embodiment of the present invention.

FIG. 2 is a flowchart illustrating a procedure of image processing according to the first embodiment.

FIG. 3 is a diagram illustrating management information.

FIG. 4 illustrates an example of an interface of the first embodiment.

FIG. 5 illustrates a modification of the interface of the first embodiment.

FIG. 6 is a flowchart illustrating a procedure of image processing according to a second embodiment of the present invention.

FIG. 7 illustrates an example of an interface of the second embodiment.

FIG. 8 is a diagram illustrating a hardware configuration of an image processing apparatus according to another embodiment of the present invention.

### DESCRIPTION OF THE EMBODIMENTS

Hereinafter, a detailed description will be given of embodiments of the present invention with reference to the accompanying drawings. It should be understood that configurations described in the following embodiments are only exemplary and that the present invention is not limited to the configurations illustrated in the drawings.

### First Embodiment

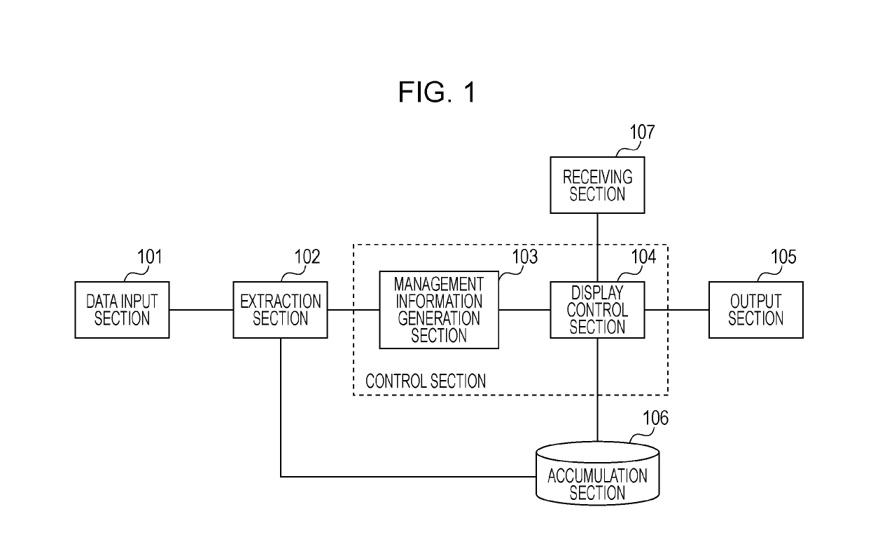

FIG. 1 is a block diagram illustrating a main part of an image processing apparatus according to a first embodiment of the present invention.

In FIG. 1, image data containing subtitle data is input into a data input section 101. In the present embodiment, image data is a data stream that is transmitted in accordance with MPEG-2 Transport Stream, but is not limited thereto. An extraction section 102 extracts subtitle data from the image data input thereto. The extraction section 102 also extracts time information that associates the subtitle data and the image data with each other. An accumulation section 106 accumulates image data input thereto. A control section includes a management information generation section 103 and a display control section 104. The management information generation section 103 generates management information from the subtitle data and the time information extracted by the extraction section 102. The display control section 104 generates a list of subtitle data segments (subtitle list) to be displayed on a display or the like, and, on the basis of an image data segment to be reproduced and a time information segment thereof, displays a corresponding subtitle in the subtitle list in an emphasized manner. A data output section 105 outputs the image data segment and the subtitle list to the display or the like. A receiving section 107 receives a reproduction instruction of a user from an input device such as a remote controller or a mouse.

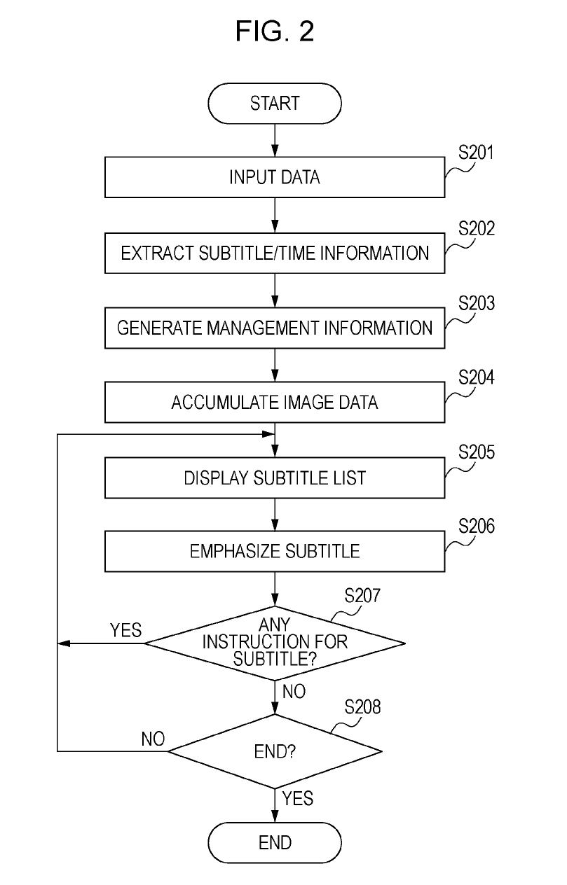

FIG. 2 is a flowchart explaining a procedure of image processing of the image processing apparatus of the present embodiment.

In step S201, image data containing subtitle data is input into the data input section 101. In step S202, the extraction section 102 extracts subtitle data and time information that associates the subtitle data and the image data with each other from the image data input thereto. The time information can be read from a Packetized Elementary Stream (PES) header in the data stream.

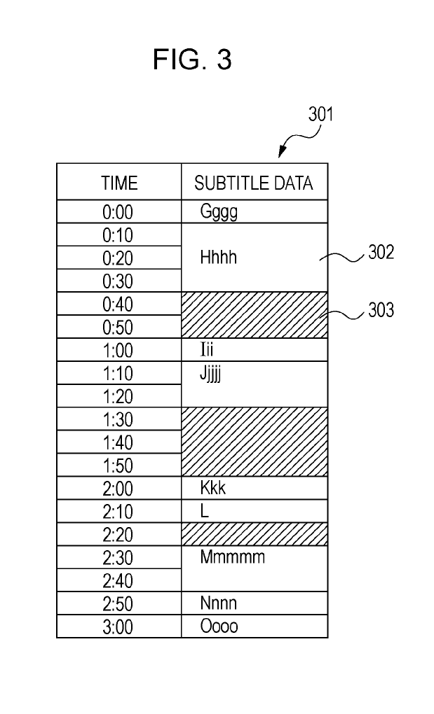

In step S203, the management information generation section 103 generates management information from the subtitle data and the time information extracted by the extraction section 102. An example of generated management information is illustrated in FIG. 3. In a table 301, the time information of the image data and the subtitle data are associated with each other. For example, a subtitle data segment “Hhhh” 302 corresponds to a reproduction time period of 0:10 to 0:30 of the image data. A shaded area 303 indicates that image data contains no subtitle data in a reproduction time period of 0:40 to 0:50. This applies to cases where, for example, an image data segment contains only scenic images. Instead of being shaded, an area for a subtitle data segment corresponding to a time period in which no subtitle data exists may be replaced with an area having information (second subtitle data) indicating that no subtitle exists, such as “no subtitle”.

In step S204, image data from which subtitle data and time information have been extracted by the extraction section 102 is accumulated in the accumulation section 106. In step S205, the display control section 104 creates a list of subtitle data segments, and causes the subtitle list and image data to be displayed on the display or the like via the output section 105. The output section 105 outputs data such as the image data and subtitle list to the display.

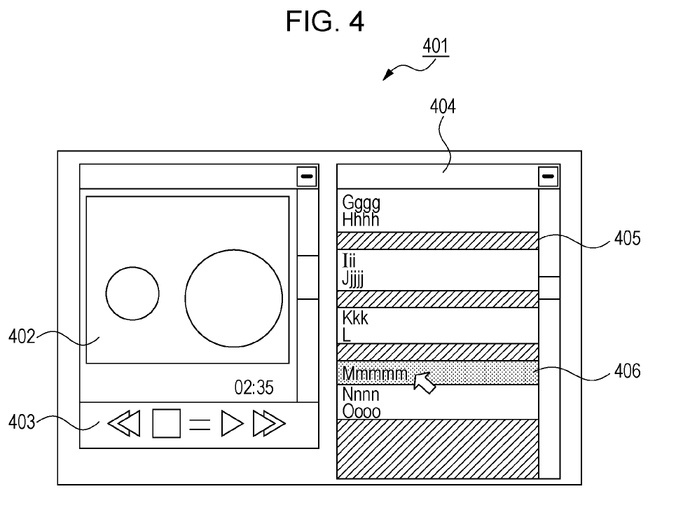

FIG. 4 shows an interface 401 of image data and a subtitle list to be displayed on the display. Numerals 402, 403, 404 and 405 respectively denote an image display region, an image operation region, a subtitle list, and an area indicating that no subtitle data exists in a corresponding image data segment. Numeral 406 indicates a subtitle data segment that corresponds to an image data segment currently being reproduced. The user can operate the image operation region by using a remote controller or a mouse to perform an operation such as fast-forwarding or fast-rewinding of the image data. The user can also operate the subtitle list and specify a subtitle to display an image data segment that corresponds to the specified subtitle in the image display region.

In step S206, the display control section 104 specifies a subtitle data segment corresponding to an image data segment being reproduced by referring to the management information created in step S203. The display control section 104 then emphasizes the specified subtitle data segment on the displayed subtitle data list. Such an emphasized display may be obtained by, for example, changing a color for the subtitle data segment, indicating the subtitle data segment in boldface, or highlighting the subtitle data segment and the background thereof as indicated by numeral 406 in FIG. 4. In addition, in the present invention, other display methods can be used as long as the specified subtitle data segment can be distinguished from the other subtitle data segments.

Step S206 continues until the reproduction of the image data is ended. That is, while the image data is being reproduced in a normal manner, the emphasized display for a subtitle data segment in the subtitle list sequentially moves down. Even when one image of an image data segment is being displayed as a still image, a subtitle data segment corresponding to the still image is displayed in an emphasized manner.

In step S207, the display control section 104 receives an instruction provided by a user for the subtitle list from the receiving section 107. In response to the instruction, the display control section 104 refers to the management information and displays an image data segment corresponding to the subtitle data segment that is subjected to the instruction. At this time, the display control section 104 may display a first still image of the image data segment corresponding to the subtitle data segment subjected to the instruction, or multiple thumbnails of the image data segment corresponding to the subtitle data segment subjected to the instruction.

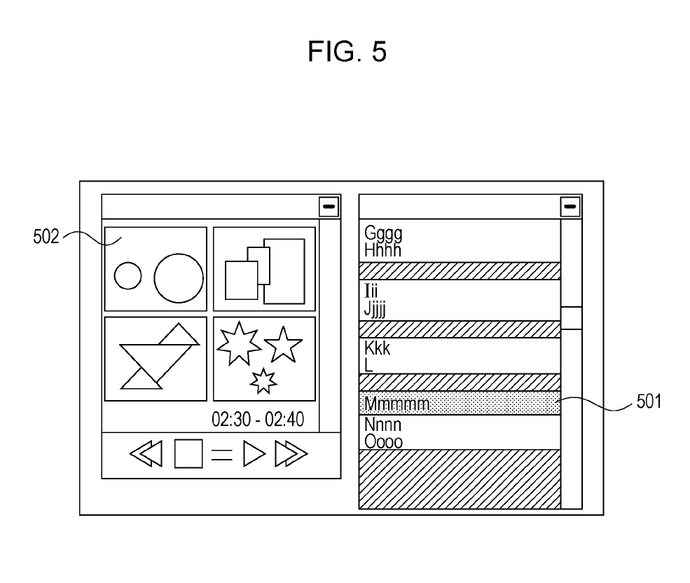

FIG. 5 shows an example of displaying multiple thumbnails. In FIG. 5, a subtitle “Mmmmm” 501 is selected from the subtitle list by an instruction provided by a user. In this case, the display control section 104 refers to the management information to specify an image data segment corresponding to the subtitle “Mmmmm” 501, selects a plurality of images from the image data segment, and causes an image data display section 502 to display the selected images as thumbnails. Images may be selected at random or scene change images may be selected. By selecting one thumbnail from among the displayed thumbnails by a user, the image corresponding to the thumbnail can be displayed on a single screen as illustrated in FIG. 4 to reproduce the image.

Finally, in step S208, the processing is terminated when displaying of the image data is completed.

Accordingly, in the first embodiment, by displaying a subtitle data segment corresponding to an image data segment in an emphasized manner, a user can refer to the subtitle data segment corresponding to the image data segment in a subtitle list. In addition, if there is a scene having no audio data/subtitle data in an image data segment, information indicating that there is no subtitle data for the scene is displayed on the subtitle list, whereby the user can visually recognize the scene having no audio data/subtitle data.

### Second Embodiment

Although the first embodiment shows an example in which subtitle data segments are simply displayed as a subtitle list, a second embodiment shows an example in which each of line spaces in the subtitle list is changed on the basis of the length of time for which a corresponding subtitle data segment is displayed. A block diagram illustrating a main part of an image processing apparatus according to the second embodiment is the same as that in FIG. 1, and is thus not repeated.

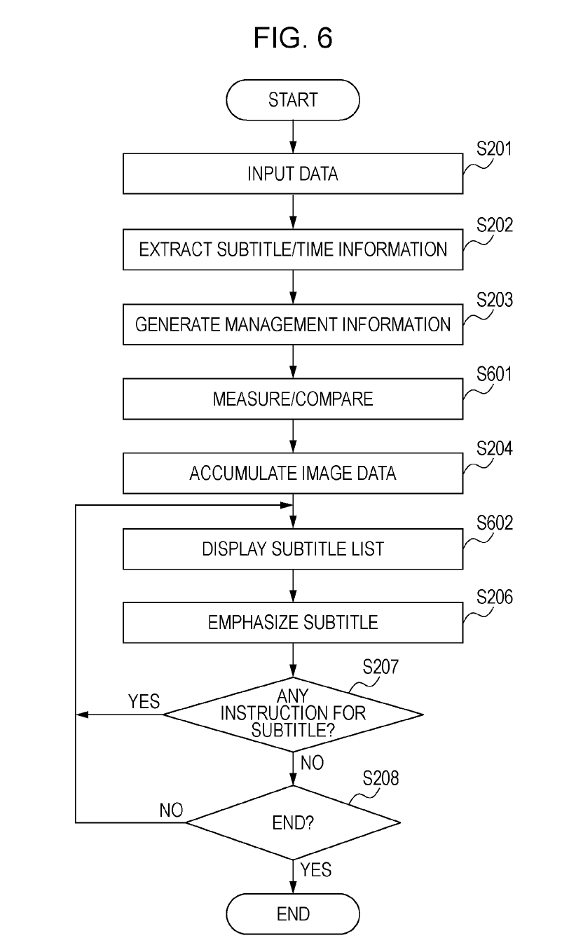

FIG. 6 is a flowchart explaining operations of the image processing apparatus according to the present embodiment. Descriptions for the same processes as those in the first embodiment are not repeated.

In step S601, the display control section 104 measures the length of time for which each of subtitle data segments (including one having information indicating there is no subtitle) is displayed on the basis of subtitle data and time information, and compares the lengths with one another. In step S602, the display control section 104 creates a list of subtitle data segments on the basis of the result of the comparison. More specifically, the display control section 104 allocates a corresponding area in a maximum display region in which the subtitle list can be displayed (including a region that can be displayed by using a scroll bar) to each subtitle data segment on the basis of the ratio of the time length for which each subtitle data segment is displayed.

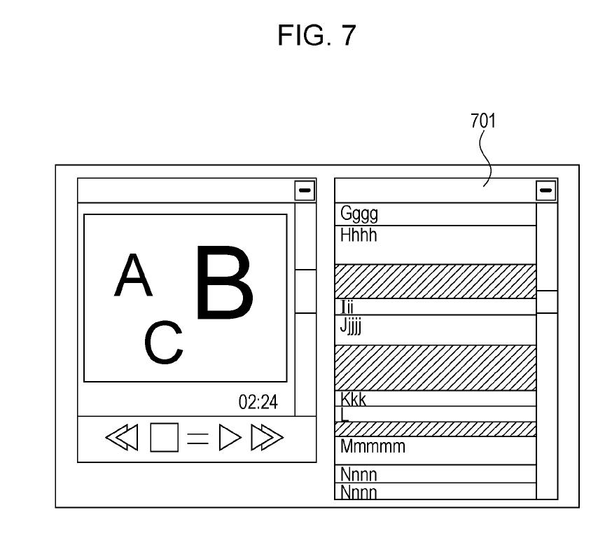

FIG. 7 illustrates an example of an interface that is displayed on the display by this processing. In a subtitle list 701, a line space differs for each subtitle data segment in accordance with the time length of displaying the corresponding subtitle data segment. That is, a subtitle data segment having a longer display time has a larger line space.

Thus, in the second embodiment, it is possible to visually recognize, from the subtitle list, the length of an image data segment for which the subtitle data segment is displayed, and it is possible to figure out the structure of image data segments from the subtitle list.

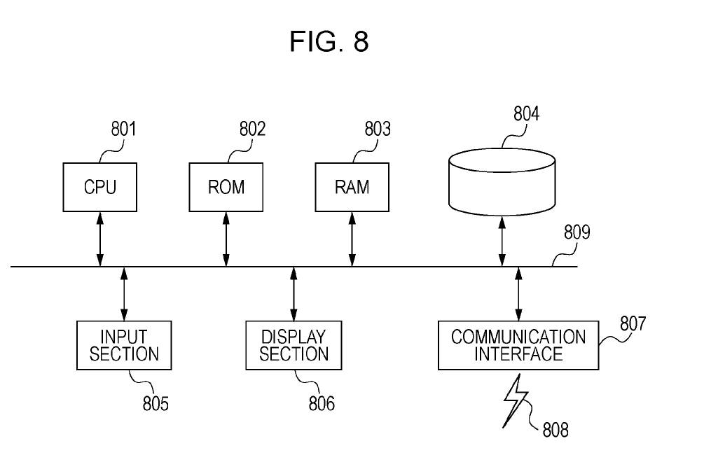

FIG. 8 is a diagram illustrating a hardware configuration of the image processing apparatus according to another embodiment. In this example, a central processing unit (CPU) 801, a read-only memory (ROM) 802, a random-access memory (RAM) 803, a hard disk 804, an input section 805, a display section 806, and a communication interface 807 are connected to a bus 809. The CPU 801 executes the above-described processes in accordance with a program stored in the ROM 802. The RAM 803 is a memory containing a work area and various tables that are used while the CPU 801 is performing the processes. The input section 805 performs image inputting from a camera or the like. The display section 806 performs image outputting on a display or the like. The communication interface 807 controls data communication with a network 808.

The present invention may be applied to a system that includes a plurality of devices (such as a host computer, an interface device, a reader, and a printer), or to an apparatus that includes a single device (such as a copying machine or a facsimile machine).

Aspects of the present invention can also be realized by a computer of a system or apparatus (or devices such as a CPU or micro-processing unit (MPU)) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. The program includes computer-executable instructions for implementing the present invention. For this purpose, the program is provided to the computer for example via a network or from a recording medium of various types serving as the memory device (e.g., computer-readable storage medium). In such a case, the system or apparatus, and the recording medium where the program is stored, are included as being within the scope of the present invention.

An operating system (OS) or other application software running on a computer can execute part or all of actual processing based on instructions of the program to realize the functions one or more of the above-described exemplary embodiments.

Additionally, the program read out of a storage medium can be written into a memory of a function expansion card inserted in a computer or into a memory of a function expansion unit connected to the computer. In this case, based on instructions of the program, a CPU or MPU provided on the function expansion card or the function expansion unit can execute part or all of the processing to realize the functions of one or more of the above-described exemplary embodiments.

A wide variety of storage media may be used to store the program. The storage medium may be, for example, any of a flexible disk (floppy disk), a hard disk, an optical disk, a magneto-optical disk, a compact disc (CD), a digital versatile disc (DVD), a read only memory (ROM), a CD-recordable (R), a CD-rewritable, a DVD-recordable, a DVD-rewritable, a magnetic tape, a nonvolatile memory card, a flash memory device, and so forth.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-328016 filed Dec. 24, 2008, which is hereby incorporated by reference herein in its entirety.

What is claimed is:

1. An image processing apparatus configured to cause a display unit to display image data segments and subtitle data segments, the image processing apparatus comprising:
an input unit configured to input image data segments;
an extraction unit configured to extract subtitle data segments and time information that associates the subtitle data segments and the image data segments with each other from the image data segments input by the input unit;
a control unit configured to create a list of the subtitle data segments to be displayed on the display unit and, based on an image data segment to be displayed on the display unit and the time information extracted by the extraction unit, control a subtitle data segment corresponding to the image data segment in the list of the subtitle data segments so that the subtitle data segment can be distinguished from the other subtitle data segments in the list of the subtitle data segments; and
an output unit configured to output the image data segment and the list of the subtitle data segments created by the control unit to the display unit.

2. The image processing apparatus according to claim 1, wherein the control unit further includes:
a generation unit configured to generate management information in which image data segments and subtitle data segments are associated with each other from the time information extracted by the extraction unit;
wherein the control unit creates the list of the subtitle data segments to be displayed on the display unit based on the management information created by the generation unit, and controls the subtitle data segment in the list of the subtitle data segments corresponding to the image data segment so that the subtitle data segment can be distinguished from the other subtitle data segments in the list of the subtitle data segments.

3. The image processing apparatus according to claim 2, wherein, when the image data segment has no corresponding subtitle data segment, the generation unit generates management information that associates the image data segment with a second subtitle data segment indicating that the image data segment has no subtitle data segment.

4. The image processing apparatus according to claim 1, wherein the control unit changes a line space of a subtitle data segment to be displayed on the display unit based on a length of time of displaying the image data segment corresponding to the subtitle data segment.

5. A method for controlling an image processing apparatus configured to cause a display unit to display image data segments and subtitle data segments, the method comprising:
an input step of inputting image data segments;
an extraction step of extracting subtitle data segments and time information that associates the subtitle data segments and the image data segments with each other from the image data segments input in the input step;
a control step of creating a list of the subtitle data segments to be displayed on the display unit and, based on an image data segment to be displayed on the display unit and the time information extracted by the extraction unit, controlling a subtitle data segment corresponding to the image data segment in the list of the subtitle data segments so that the subtitle data segment can be distinguished from the other subtitle data segments in the list of the subtitle data segments; and
an output step of outputting the image data segment and the list of the subtitle data segments created in the control step to the display unit.

6. A computer-readable storage medium storing a program of computer-executable instructions for causing a computer to execute the method according to claim 5.
